(19) United States
(12) Patent Application Publication
(10) Pub. No.: US 2026/0141040 A1
(43) Pub. Date: May 21, 2026

(54) FAILSAFE AUTHORIZATION USING RECORD VALUE

(71) Applicant: Visa International Service Association, San Francisco, CA (US)

(72) Inventors: Vishnu Vardhan Rao Chitneni, Austin, TX (US); Veera Ravi Nanda Kishore Vadlamannati, Austin, TX (US)

(73) Assignee: Visa International Service Association, San Francisco, CA (US)

(21) Appl. No.: 18/949,845

(22) Filed: Nov. 15, 2024

(51) Int. Cl. G06F 21/31

(52) U.S. Cl. CPC G06F 21/31

(57) ABSTRACT

A method is disclosed. It includes receiving, from a resource provider computer, an authorization request message comprising a credential or a token, and a value for an interaction, and transmitting the authorization request message comprising the credential, and the value to a first authorizing entity computer. The method includes receiving an authorization response message from the first authorizing entity computer, the authorization response message comprising an indication that the first authorizing entity computer is unable to provide an authorization decision on the authorization response message. The method includes determining that the credential is associated with a flagged record, and then generating a subsequent authorization request message comprising the credential or data associated with the credential, the value, and a record value of a record managed by the first authorizing entity computer.

### CROSS-REFERENCES TO RELATED APPLICATIONS

None.

### BACKGROUND

In a typical transaction (e.g., a transaction to access a location, access secure data, or a resource such as a good or service), an authorizing entity computer may receive an authorization request message from a resource provider computer. The authorizing entity computer can analyze the authorization request message and can respond to the resource provider computer with an authorization response message.

In some cases, the authorizing entity computer is unable to provide the authorization response message to the resource provider computer. In one example, the authorizing entity computer may be offline for technical reasons (e.g., a software or hardware malfunction). In another example, the authorizing entity computer may be turned off due to other issues such as financial issues (e.g., when an authorizing entity operating the authorizing entity computer becomes insolvent or illiquid).

Embodiments of the disclosure address these problems and other problems individually and collectively.

### BRIEF SUMMARY

One embodiment of the invention includes a method comprising: receiving, by a processing network computer from a resource provider computer, an authorization request message comprising a credential or a token, and a value for an interaction; transmitting, by the processing network computer, the authorization request message comprising the credential, and the value to a first authorizing entity computer; receiving, by the processing network computer, an authorization response message from the first authorizing entity computer, the authorization response message comprising an indication that the first authorizing entity computer is unable to provide an authorization decision on the authorization response message; determining, by the processing network computer, that the credential is associated with a flagged record; responsive to determining that the credential is associated with the flagged record, generating, by the processing network computer, a subsequent authorization request message comprising the credential or data associated with the credential, the value, and a record value of a record managed by the first authorizing entity computer; and transmitting, by the processing network computer, the subsequent authorization request message to a second authorizing entity computer, wherein the second authorizing entity computer authorizes or declines the subsequent authorization request message.

Another embodiment includes a processing computer comprising: a processor; and a computer readable medium comprising instructions, executable by the processor, for performing operations comprising: receiving, from a resource provider computer, an authorization request message comprising a credential or a token, and a value for an interaction; transmitting the authorization request message comprising the credential, and the value to a first authorizing entity computer; receiving an authorization response message from the first authorizing entity computer, the authorization response message comprising an indication that the first authorizing entity computer is unable to provide an authorization decision on the authorization response message; determining that the credential is associated with a flagged record; responsive to determining that the credential is associated with the flagged record, generating a subsequent authorization request message comprising the credential or data associated with the credential, the value, and a record value of a record managed by the first authorizing entity computer; and transmitting the subsequent authorization request message to a second authorizing entity computer, wherein the second authorizing entity computer authorizes or declines the subsequent authorization request message.

These and other embodiments are described in further detail below.

### TERMS

Before discussing specific embodiments of the invention, some descriptions of some terms may be helpful.

An “authorization entity” or “authorizing entity” may be an entity that authorizes a request. Examples of an authorization entity may be an issuer, a governmental agency, a document repository, an access administrator, etc. An authorization entity may operate an authorizing entity computer.

An “issuer” may refer to a business entity (e.g., a bank) that issues and optionally maintains an account for a user. An issuer may also issue payment credentials stored on a user device, such as a cellular telephone, smart card, tablet, or laptop to the consumer.

A “resource provider” may be an entity that can provide a resource such as goods, services, information, and/or access to a location (e.g., a parking space, a transit terminal, etc.). Examples of resource providers include merchants, governmental authorities, secure data providers, etc. A resource provider may operate one or more access devices.

An “access device” may be any suitable device that provides access to a resource. An access device may be in any suitable form. Some examples of access devices include vending machines, kiosks, POS or point of sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), and the like. An access device may use any suitable contact or contactless mode of operation to send or receive data from, or associated with, a user mobile communication device. In some embodiments, an access device may include a reader, a processor, and a computer-readable medium. A reader may include any suitable contact or contactless mode of operation. For example, exemplary readers can include radio frequency (RF) antennas, optical scanners, bar code readers, or magnetic stripe readers to interact with a payment device and/or mobile communication device.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer.”

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “mobile communication device” may comprise any suitable electronic device that may be transported and operated by a user, which may also optionally provide remote communication capabilities to a network. Examples of remote communication capabilities include using a mobile phone (wireless) network, wireless data network (e.g., 3G, 4G or similar networks), Wi-Fi, Bluetooth, Bluetooth Low Energy (BLE), Wi-Max, or any other communication medium that may provide access to a network such as the Internet or a private network. Examples of mobile communication devices include mobile phones (e.g., cellular phones), PDAs, tablet computers, net books, laptop computers, wearable devices (e.g., watches), vehicles such as automobiles and motorcycles, personal music players, hand-held specialized readers, etc. A mobile communication device may comprise any suitable hardware and software for performing such functions, and may also include multiple devices or components (e.g., when a device has remote access to a network by tethering to another device-i.e., using the other device as a modem - both devices taken together may be considered a single mobile communication device).

A “user” may include an individual. In some embodiments, a user may be associated with one or more personal accounts and/or user devices. The user may also be referred to as a cardholder, account holder, or consumer in some embodiments.

A “user device” may be a device that is operated by a user. Examples of user devices may include a mobile phone, a smartphone, a card, a payment card, a personal digital assistant (PDA), a laptop computer, a desktop computer, a server computer, a vehicle such as an automobile, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G, or similar networks), Wi-Fi, Wi-Max, or any other communication medium that may provide access to a network such as the Internet or a private network.

An “access device” may refer to a device used to access something, such as a network or computer system. For example, a point of sale terminal or the phone of a merchant can comprise an access device used to gain access to a payment processing network. An access device may comprise a means by which it can interface with other devices. For example, an access device may include a chip card reader including conductive contacts used to interface with a smartcard user device.

A “resource” can be something of value to a user. A resource, for example, can include digital items and/or physical items. A resource can be an obtainable item. A resource can be owned by an entity. A resource can be a physical item such as goods. A resource can be a service that is provided by a merchant. A resource can be a digital item such as non-fungible tokens, secure data, etc. Another example of a resource is access to a secure or otherwise access-controlled location.

A “credential” may be any suitable information that serves as reliable evidence of worth, ownership, identity, or authority. A credential may be a string of numbers, letters, or any other suitable characters that may be present or contained in any object or document that can serve as confirmation.

A “value credential” may be information associated with worth. Examples of value credentials include payment credentials, coupon identifiers, information needed to obtain a promotional offer, etc.

“Payment credentials” may include any suitable information associated with an account (e.g., a payment account and/or payment device associated with the account). Such information may be directly related to the account or may be derived from information related to the account. Examples of account information may include a PAN (primary account number or “account number”), username, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors). Payment credentials may be any information that identifies or is associated with a payment account. Payment credentials may be provided in order to make a payment from a payment account. Payment credentials can also include a username, an expiration date, a gift card number or code, and any other suitable information.

A “token” may be a substitute value for a credential. A token may be a string of numbers, letters, or any other suitable characters. Examples of tokens include access tokens such as payment tokens, data that can be used to access secure systems or locations, etc.

A “payment token” may include an identifier for a payment account that is a substitute for an account identifier, such as a primary account number (PAN) and/or an expiration date. For example, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing transaction processing networks (e.g., ISO 8583 financial transaction message format). In some embodiments, a token may be used in place of a PAN to initiate, authorize, settle or resolve a payment transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which sensitive data is replaced with substitute data. For example, a real credential (e.g., a primary account number (PAN)) may be tokenized by replacing the real account identifier with a substitute number that may be associated with the real credential. Further, tokenization can be applied to any other information to substitute the underlying information with a token. “Token exchange” or “detokenization” can be a process of restoring the data that was substituted during tokenization. For example, a token exchange may include replacing a payment token with its associated primary account number (PAN). Further, detokenization or token exchange may be applied to any other information to retrieve the substituted information from a token. In some embodiments, token exchange can be achieved via a transactional message, such as an ISO message, an application programming interface (API), or another type of web interface (e.g., web request).

A “token service computer” can include a system that that services tokens. In some embodiments, a token service computer can facilitate requesting, determining (e.g., generating) and/or issuing tokens, as well as maintaining an established mapping of tokens to primary account numbers (PANs) in a repository (e.g., token vault). In some embodiments, the token service computer may establish a token assurance level for a given token to indicate the confidence level of the token to PAN binding. The token service computer may include or be in communication with a token vault where the generated tokens are stored. The token service computer may support token processing of payment transactions submitted using tokens by detokenizing the token to obtain the actual PAN.

A “token domain” may indicate an area and/or circumstance in which a token can be used. Examples of the token domain may include, but are not limited to, payment channels (e.g., e-commerce, physical point of sale, etc.), POS entry modes (e.g., contactless, magnetic stripe, etc.), and merchant identifiers to uniquely identify where the token can be used. A set of parameters (i.e., token domain restriction controls) may be established as part of token issuance by the token service computer that may allow for enforcing appropriate usage of the token in payment transactions. For example, the token domain restriction controls may restrict the use of the token with particular presentment modes, such as contactless or e-commerce presentment modes. In some embodiments, the token domain restriction controls may restrict the use of the token at a particular merchant that can be uniquely identified. Some exemplary token domain restriction controls may require the verification of the presence of a token cryptogram that is unique to a given transaction. In some embodiments, a token domain can be associated with a token requestor.

“Token expiry date” may refer to the expiration date/time of the token. The token expiry date may be passed among the entities of the tokenization ecosystem during transaction processing to ensure interoperability. The token expiration date may be a numeric value (e.g., a 4-digit numeric value). In some embodiments, the token expiry date can be expressed as a time duration as measured from the time of issuance.

An “authorization request message” may be a message that requests permission to conduct an interaction. For example, an authorization request message may include an electronic message that is sent to a payment processing network and/or an issuer of a payment card to request authorization for a transaction. An authorization request message according to some embodiments may comply with (International Organization of Standardization) ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message. In some embodiments, it may be generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g., POS equipment) that indicates approval of the transaction. The code may serve as proof of authorization. As noted above, in some embodiments, a payment processing network may generate or forward the authorization response message to the merchant.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

### BRIEF DESCRIPTION OF THE DRAWINGS

FIG. 1 shows a block diagram of a system, according to an embodiment.

FIGS. 2A and 2B show flow diagrams illustrating methods according to embodiments of the invention.

FIG. 3 shows a block diagram of a processing network computer, according to an embodiment.

FIG. 4 shows a block diagram of an authorizing entity computer, according to an embodiment.

### DETAILED DESCRIPTION

Embodiments of the invention provide for a failsafe authorization process that enables a second authorizing entity computer to authorize a transaction conducted by a user in the event that a first authorizing entity computer that would normally authorize the transaction has failed. The failure of the first authorizing entity computer can occur for a number of reasons. For example, the first authorizing entity computer may fail due to a technical or network malfunction. In another example, the first authorizing entity computer can fail because the first authorizing entity operating the first authorizing entity computer has become insolvent or illiquid.

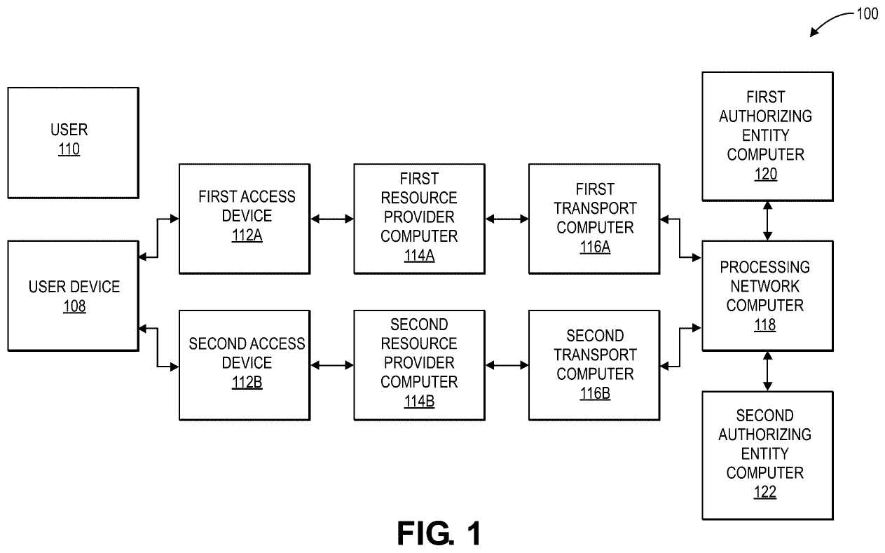

FIG. 1 shows a block diagram of a system 100, according to an embodiment. System 100 includes a user 110 that operates a user device 108. The user device can interact with one or more access devices including a first access device 112A in communication with a first resource provider computer 114A, and/or a second access device 112B in communication with a second resource provider computer 114B. The first resource provider computer 114A and second resource provider computer 114B can be in communication with a processing network computer 118 via a first transport computer 116A and a second transport computer 116B, respectively. The processing network computer 118 can be in communication with various authorizing entity computers including a first authorizing entity computer 120, and a second authorizing entity computer 122. Although two access devices, resource provider computers, transport computers, and authorizing entity computers are shown for clarity of illustration, embodiments of the invention can include a number of additional computers and devices.

The devices and computers in the system 100 can communicate with one another using a communication network or line (not pictured). The communication network or line can take any suitable form, and may include any one and/or the combination of the following: a direct connection or interconnection; the Internet; a Local Area Network (LAN); a Metropolitan Area Network (MAN); an operating Missions as Nodes on the Internet (OMNI); a cellular network, a secured custom connection; a Wide Area Network (WAN); a wireless network (e.g., employing protocols such as, but not limited to a Wireless Application Protocol (WAP), I-mode, and/or the like); and/or the like. Messages between the computers and devices in system 100 may be transmitted using a communication protocol such as, but not limited to, File Transfer Protocol (FTP); Hypertext Transfer Protocol (HTTP); Secure Hypertext Transfer Protocol (HTTPS); Secure Socket Layer (SSL), ISO (e.g., ISO 8583) and/or the like.

The user 110 may operate the user device 108 to obtain a resource from a first resource provider of the resource provider computer 114. The user device 108 may include a credential or a token (that is a substitute for the credential). The credential may be associated with an account managed by the first authorizing entity computer.

In certain embodiments, the user device 108 can interact with (e.g., communicate with) an access device such as the first access device 112A. During the interaction, the user device 108 and the first access device 112A can be in communication with each other and one or many messages may pass between them during the interaction.

The user device 108 may be in any suitable form. For example, the user device 108 may be, for example, a mobile phone, a personal computer (e.g., a laptop computer), a wearable device, or a card. For example, the user device 108 can be in the form of a card such as a payment card or an access badge.

In some embodiments, the user device 108 may include a contactless element for interfacing with an access device (e.g., the access device 112). The contactless element may include a chip, and may include the capability to communicate and transfer data using near field communications (NFC) technology or other short-range communications technology. The user device 108 may also include a memory, which may store user information such as one or more account numbers, one or more expiration dates associated with the one or more account numbers, cryptograms, etc. If the user device 108 is in the form of a card, it may have printed or embossed information such as a name and account number. In some cases, it may also have a magnetic stripe.

In some embodiments that do not involve financial transactions, the system 100 can allow a user 110 of the user device 108 to access a secure location. In such embodiments, the access device 112 can grant or deny access to the user 110, based on interactions with the user device 108.

The resource provider computer such as the first resource provider computer 114A can be a computer system operated by a first resource provider that also operates the first access device 112A. In some embodiments, the first resource provider computer 114A could comprise a merchant backend computer connected to the point of sale terminal (which can be an example of a first access device 112A).

In some embodiments, the transport computer such as the first transport computer 116 can be an acquirer computer associated with an acquiring bank that manages an account on behalf of the resource provider (e.g., a merchant).

The processing network computer 118 could comprise a computer that is part of a payment processing network (e.g., the Visa payment processing network). In some embodiments, the processing network computer 118 may include data processing subsystems, networks, and operations used to support and deliver authorization services, exception file services, transaction scoring services, and clearing and settlement services. An exemplary transaction processing system may include VisaNet™. Transaction processing systems such as VisaNet™ are able to process credit card transactions, debit card transactions, and other types of commercial transactions. VisaNet™, in particular, may include a VIP system (Visa Integrated Payments system) which processes authorization requests and a Base II system which performs clearing and settlement services.

The first authorizing entity computer 120 can be a computer that is programmed to receive, evaluate, and process authorization request messages, and also perform clearing and settlement processing. The first authorizing entity computer 120 can be a first issuer computer operated by an issuer. The first authorizing entity computer 120 can analyze the authorization request message and determine whether or not to authorize the transaction. The analysis performed by the first authorizing entity computer 120 can include a risk evaluation. The risk evaluation can include evaluating an indicator, a transaction amount, the time of the transaction, the recent frequency of transactions, etc., to determine if one or more of these elements are indicative of potentially fraudulent activity. The first authorizing entity computer 120 can generate an authorization response message, indicating whether the transaction has been approved or declined.

The second authorizing entity computer 122 may also be a can be a computer that is programmed to receive, evaluate, and process authorization request messages, and also perform clearing and settlement processing. The second authorizing entity computer 122 can be operated by another issuer or an insuring entity such as the FDIC (Federal Deposit Insurance Corporation).

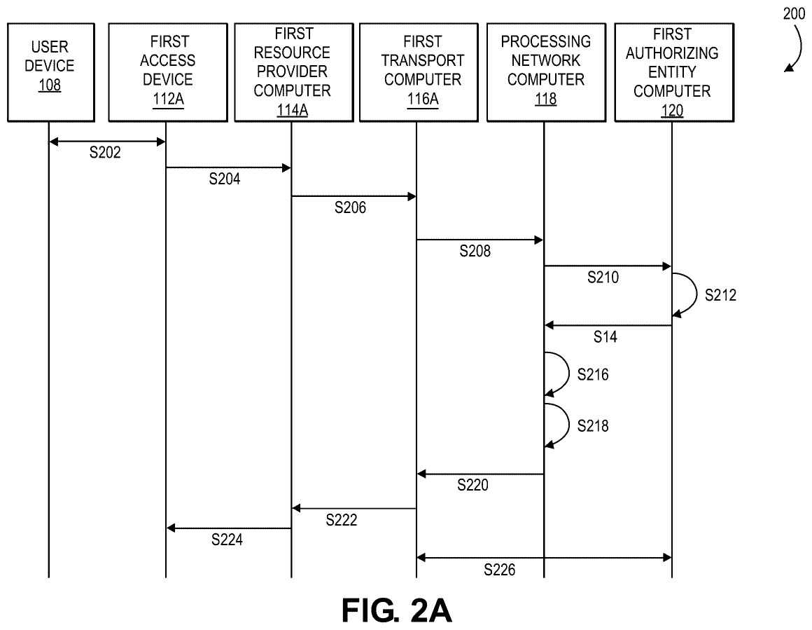

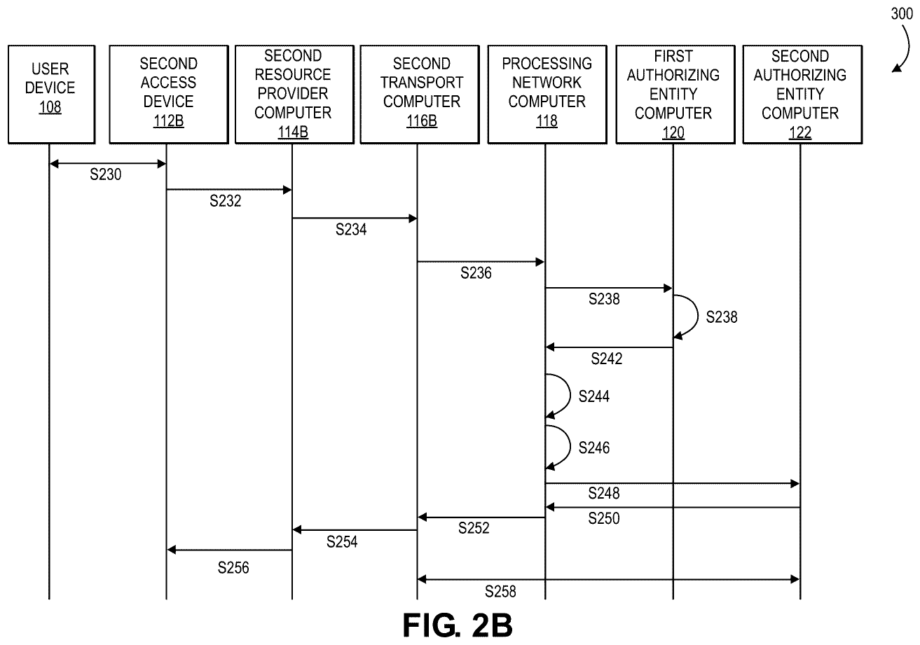

FIG. 2A shows a method of a user conducting a first interaction such as a first transaction. In the transaction, a record amount (e.g., an account balance) for the user's account can be transmitted from the first authorizing entity computer 120 to the processing network computer 118 in a first authorization response message.

The user of the user device 108 may want to obtain a resource from a first resource provider operating the first access device 112A and the first resource provider computer 114A. The resource may be a good or service, or access to secure location or secure data.

At step S202, the user device 108 may interact with the first access device 112A. The user device 108 may transmit or provide a credential (e.g., debit card number) to the first access device 112A. The first access device 112A may receive the credential from the user device 108. In some embodiments, the credential may have been tokenized and the user device 108 can transmit or provide a token to the first access device 112A.

At step S204, the first access device 112A may transmit a first authorization request message to the first resource provider computer 114A. The authorization request message may include a first value (e.g., transaction amount, area identifier of building access requested, etc.), and a credential or token.

At step S206, after receiving the first authorization request message, the first resource provider computer 114A may transmit the first authorization request message to the first transport computer 116A.

At step S208, after receiving the authorization request message, the first transport computer 116A determine the processing network computer 118 using the credential (or token). In some cases, one digit (e.g., the first digit) of a credential can indicate which processing network computer 118 to route the first authorization request message. The first transport computer 116A may transmit the first authorization request message to the processing network computer 118, and the processing network computer 118 can receive the first authorization request message.

After receiving the first authorization request message, the processing network computer 118 may determine the first authorizing entity computer by analyzing the credential. In some cases, the credential can have an identifier (e.g., a BIN or bank identification number) for the first authorizing entity computer 120. The processing network computer 118 may then transmit the first authorization request message to the first authorizing entity computer 120. The first authorization request message may include the credential and the first value (e.g., a transaction amount). The credential (e.g., a PAN or primary account number) may be associated with an account associated with the first authorizing entity computer 120 and/or the user device 108.

In some embodiments, if the first authorization request message comprises a token instead of a credential, the processing network computer 118 can detokenize the token to obtain the credential associated with the token. The processing network computer 118 can include PAN/token mappings.

At step S210, the processing network computer 118 transmits the authorization request message comprising the credential and the first value to the first authorizing entity computer 120.

At step S212, the first authorizing entity computer 120 determines whether or not to authorize the transaction. The first authorizing entity computer 120 can analyze the credential to identify the account associated with the first authorizing entity computer 120. It can then determine if the account has sufficient funds and/or credit to conduct the transaction. Fraud checks may also be conducted with respect to the first transaction.

At step S214, after making an authorization decision, the first authorizing entity computer 120 can determine a record value of the account associated with the credential. The record value can be an current balance of the account or an account balance range (e.g., $1000-$2000). A record value in the form of a range can be beneficial as an estimate of the liquidity of the user, and can also be privacy preserving since an actual account balance is not used. The first authorizing entity computer 120 then generates a first authorization response message comprising the authorization decision, the credential, and the record value. The first authorizing entity computer 120 then transmits the first authorization response message to the processing network computer 118.

At step S216, after receiving the first authorization response message, processing network computer 118 stores the record value in a database along with the credential, and an identifier for the first authorizing entity, and optionally with details associated with the first transaction (e.g., a time stamp).

At step S218, the processing network computer 118 optionally re-tokenizes the credential in the first authorization response message if the original authorization request message contained a token instead of a credential.

At steps S222, S224, and S226, the first authorization response message is transmitted to the first access device 112A via the first transport computer 116A and the first resource provider computer 114A. Assuming that the first transaction is approved, the user of the user device 108 may obtain the desired resource from the first resource provider.

At step S226, a clearing and settlement process can take place between the first transport computer 116A, the processing network computer 118, and the first authorizing entity computer 120.

FIG. 2B shows a method of the user of the user device 108 conducting a second interaction such as a second transaction. In the second transaction, the first authorizing entity computer 120 is unable to provide a response to a second authorization request message. Note that the use of the terms “first” and “second” in FIGS. 2A and 2B are intended to identify and differentiate steps and entities, and their use is not limited. For example, the user of the user device 108 could conduct many interactions or many transactions in between the first transaction in FIG. 2A and the second transaction in FIG. 2B.

In FIG. 2B, the user of the user device 108 may want to obtain a second resource from a second resource provider operating the second access device 112B and the second resource provider computer 114B. The second resource may be a good or service, or access to secure location or secure data.

At step S230, the user device 108 may interact with the second access device 112B. The user device 108 may transmit or provide a credential (e.g., debit card number) to the second access device 112B. The second access device 112B may receive the credential from the user device 108. In some embodiments, the credential may have been tokenized and the user device 108 can transmit or provide a token to the second access device 112B.

At step S232, the second access device 112B may transmit a second authorization request message to the second resource provider computer 114B. The second authorization request message may include a second value (e.g., transaction amount, area identifier of building access requested), and a credential or token.

At step S234, after receiving the authorization request message, the second resource provider computer 114B may transmit the second authorization request message to the second transport computer 116B.

At step S236, after receiving the second authorization request message, the second transport computer 116B can determine the processing network computer 118 using the credential (or token). The second transport computer 116B may then transmit the second authorization request message to the processing network computer 118, and the processing network computer 118 can receive the second authorization request message.

In some embodiments, if the second authorization request message comprises a token instead of a credential, the processing network computer 118 can detokenize the token to obtain the credential associated with the token. The processing network computer 118 can include PAN/token mappings.

At step S238, after identifying the first authorizing entity computer 120 using the credential, the processing network computer 118 transmits the second authorization request message to the first authorizing entity computer 120.

In some embodiments, the first authorizing entity computer 120 may receive the second authorization request message from the processing network computer 118. In certain embodiments, the first authorizing entity computer 120 does not receive the authorization request message (e.g., the first authorizing entity computer 120 is offline or is without power).

At step S240, after the second authorization request message is sent to the first authorizing entity computer 120, the first authorizing entity computer 120 may be unable to provide an authorization decision. For example, the first authorizing entity computer 120 may be unable to provide the authorization decision. In some cases, (i) an error code is received from the first authorizing entity computer 120 (e.g., indicating insolvency, closure, network issues) or (ii) an authorization response message is not received from the first authorizing entity computer 120 (e.g., the first authorizing entity computer 120 is offline or is without power).

At step S242, if the first authorizing entity computer 120 is able to respond, the first authorizing entity computer 120 may send a second authorization response message to the processing network computer 118 indicating the inability to provide the authorization decision. In some cases, the second authorization response message may include a code which indicates the reason why it is not able to respond (e.g., an insolvency code, a network error code, etc.). In certain embodiments, no response message is received from the first authorizing entity computer 120.

At step S244, the processing network computer 118 analyzes the second authorization response message (if it was sent). Alternatively, the processing network computer 118 can determine that no authorization response message was sent by the first authorizing entity computer 120 if one was not received within a predetermined time (e.g., the message timed out).

At step S246, the processing network computer 118 may also determine if the second authorization request message (or a derivative thereof such as a subsequent authorization request message) should be transmitted to the second authorizing entity computer 122. The determination may be based on whether the credential (or token) associated with the authorization request message is associated with a flagged account (e.g., flagging that the account is insured or backed by the second authorizing entity computer 122). In some embodiment, the account may be flagged only after an entity (e.g., the FDIC) determines that there is a problem (e.g., insolvency) with the first authorizing entity that operates the first authorizing entity computer 120.

At step S248, if the processing network computer 118 determines that the account associated with the credential is a flagged account, and it may then transmit a subsequent authorization request message to the second authorizing entity computer 122. The subsequent authorization request message may comprise the credential and/or data associated with the credential, the second value, and the record value.

In some embodiments, the data associated with the credential could be another credential that is not the credential. For example, the credential could be an account number that has a BIN (bank identification number), which identifies the first authorizing entity computer 120. Another credential could be an account number that has a BIN, which identifies the second authorizing entity computer 122. In other embodiments, a second credential could be used to route the subsequent authorization request message to the second authorizing entity computer 122. The original credential could be in a separate data field in the subsequent authorization request message. In both cases, the second authorizing entity computer 122 will be able to identify the account associated with the credential in the second authorization request message.

At step S250, after the second authorizing entity computer 122 receives the subsequent authorization request message, the second authorizing entity computer 122 may determine whether it can authorize the second transaction associated with the second value in the subsequent authorization request message. The second authorizing entity computer 122 can make this determination, based at least in part on the record value that is in the subsequent authorization request message. The second authorizing entity computer 122 can compare the second value to the record value. If the second value is less than the record value, then it may approve of the second transaction. The second authorizing entity computer 122 can generate and transmit a subsequent authorization response message comprising the second credential and an approve or decline indicator to the processing network computer 210.

In some embodiments, the second authorizing entity computer 122 may only authorize an amount that is less than a predefined percentage (e.g., 70 percent) of the record value. For example, if the second value is $900 and the record value is $1000, then the second authorizing entity computer 122 may only authorize seventy percent or $700 of the record value. This may be done to mitigate against any risk.

At steps S252, S254, and S246, the processing network computer 118 can transmit the subsequent response message the second access device 112B via the second transport computer 116B and the second resource provider computer 114B. The second access device 112B may then display a message indicating the status of the subsequent authorization response message (e.g., approved, denied, etc.).

After the authorization processing has been completed, the second resource provider computer 114B may generate a transaction submission with the transaction data (including the credential) for the above-described transaction and other transactions and transmit it to the second transport computer 116B.

At step S258, a clearing and settlement process can be performed. In some embodiments, the second transport computer 116B may generate a clearing file. The clearing file may be sent by the second transport computer 116B to the processing network computer 118. The processing network computer 118 may use the clearing file to generate settlement files, the settlement files may be sent to one or more authorizing entity computers (e.g., the first authorizing entity computer 120, the second authorizing entity computer 122).

According to certain embodiments, the transaction details may be exchanged between the first authorizing entity computer 120 and the second authorizing entity computer 122. Such information can be used to perform reconciliation and settle obligations between the second authorizing entity operating the second authorizing entity computer 122 and the first authorizing entity operating the first authorizing entity computer 120. For example, if the first authorizing entity computer 120 failed to respond to authorization request messages because it was insolvent, and if it later became solvent, then the transaction details may be used by the first authorizing entity to reimburse the second authorizing entity for the payment of the prior transaction.

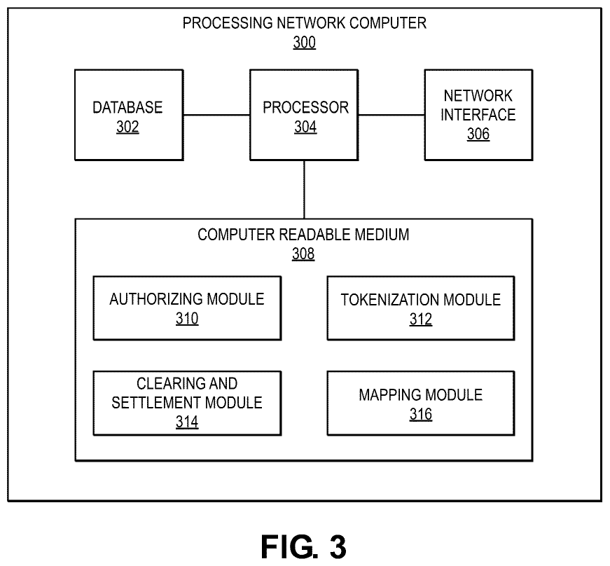

FIG. 3 shows a block diagram of a processing network computer 300, according to an embodiment. The processing network computer 300 comprises a processor 304. A network interface 306, a database 302, and a computer readable medium 308 are coupled to the processor 304.

The computer readable medium 308 may be formed from any suitable combination of hardware and/or software. It may store computer code to accomplish the functions of the processing network computer 300. For example, it may comprise a number of software modules comprising an authorization module 310, a clearing and settlement module 314, and a tokenization module 312

The computer readable medium 308 can comprise code, executable by the processor 304 for performing a method comprising: receiving, from a resource provider computer, an authorization request message comprising a credential or a token, and a value for an interaction; transmitting the authorization request message comprising the credential, and the value to a first authorizing entity computer; receiving an authorization response message from the first authorizing entity computer, the authorization response message comprising an indication that the first authorizing entity computer is unable to provide an authorization decision on the authorization response message; determining that the credential is associated with a flagged record; responsive to determining that the credential is associated with the flagged record, generating a subsequent authorization request message comprising the credential or data associated with the credential, the value, and a record value of a record managed by the first authorizing entity computer; and transmitting the subsequent authorization request message to a second authorizing entity computer, wherein the second authorizing entity computer authorizes or declines the subsequent authorization request message.

The authorization module 310 may comprise code for performing authorization processing. Authorization processing may include the routing, generation, or modification of authorization request messages.

The tokenization module 312 may comprise code for performing token processing including token generation, tokenization of data, and de-tokenization of data. The tokenization module 312 may cause a generated token to be related to a credential, the relationship may be stored in the database 302.

The clearing and settlement module 314 may comprise code for performing settlement processing. Settlement processing may include the generating, routing, or modification of clearing messages and the settlement of funds.

The mapping module 316 can comprise code for mapping record values to credentials and authorizing entity computers in the database 302. It can also update record values as new authorization response messages with record values are received by the processing network computer 300.

The network interface 306 may be configured to allow the processing network computer 300 to communicate with other entities such as the transport computer 208, the first authorizing entity computer 120, and the second authorizing entity computer 122. Network interfaces may accept, communicate, and/or connect to a communications network. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

The database 302 can store data. Such data may include data can include tokens, credentials, transaction data, record values, authorizing entity computer identifiers, and the like. The database may be a conventional, fault tolerant, relational, scalable, secure database such as Oracle or Sybase.

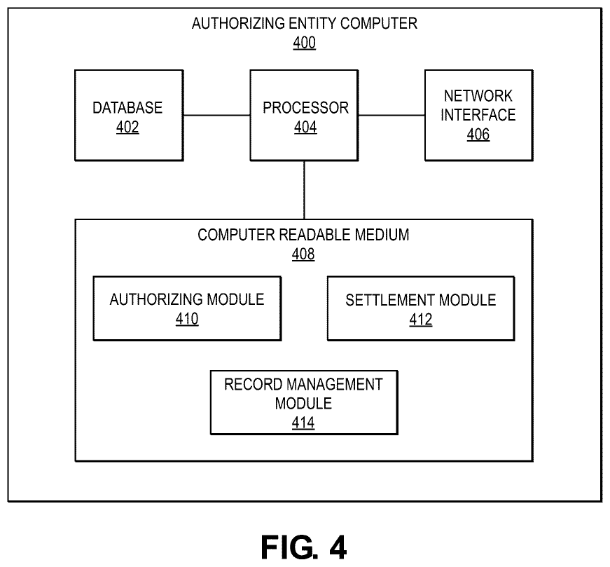

FIG. 4 shows a block diagram of an authorizing entity computer 400, according to an embodiment.

The authorizing entity computer 400 comprises a processor 404. A network interface 406, a database 402, and a computer readable medium 408 are coupled to the processor.

The computer readable medium 408 may be formed from any suitable combination of hardware and/or software. It may store computer code to accomplish the functions of the authorizing entity computer 400. For example, it may comprise a number of software modules comprising an authorization module 410, a settlement module 412, and a record management module 414.

The authorization module 410 may comprise code for performing authorization processing. Authorization processing may include generating authorization response messages, and evaluating whether or not authorization request message are authorized or declined.

The settlement module 412 may comprise code for performing settlement processing. Settlement processing may include receiving clearing files, processing the clearing files, and transferring funds to the transport computer.

The record management module 414 may comprise code for managing records and record values (e.g., balances) associated with accounts.

The network interface 406 may be configured to allow the authorizing entity computer 400 to communicate with other entities such as the transport computer 208, the first authorizing entity computer 120, and the processing network computer 210.

The database 402 can store data such as account data, record values, credentials, etc. The database may be a conventional, fault tolerant, relational, scalable, secure database such as Oracle or Sybase.

Embodiments of the invention have a number of technical advantages. For example, embodiments of the invention allow transactions to proceed even when a first authorizing entity computer is unable to respond. A second authorizing entity computer can respond on behalf of the first authorizing entity computer, and the first and second authorizing entity computers do not have to communicate with each other prior to any stand in authorizations performed by the second authorizing entity computers. The processing network computer can store current record values (e.g., balances) associated with accounts at authorizing entity computers. The record values can be used by the second authorizing entity computers to determine if transactions can be authorized. This saves on a number of communications thereby resulting in improved processing efficiency.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The figures and above description are illustrative and is not restrictive. In the above description, for the purposes of explanation, specific details are set forth in order to provide a thorough understanding of certain embodiments. However, it will be apparent that various embodiments may be practiced without these specific details. Many variations of the techniques described herein may become apparent to those skilled in the art upon review of the disclosure. The scope of the techniques can, therefore, be determined not with reference to the above description, but instead can be determined with reference to the pending claims along with their full scope or equivalents.

One or more features from any embodiment may be combined with one or more features of any other embodiment without departing from the scope of the techniques.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

What is claimed is:

1. A method comprising:
receiving, by a processing network computer from a resource provider computer, an authorization request message comprising a credential or a token, and a value for an interaction;
transmitting, by the processing network computer, the authorization request message comprising the credential, and the value to a first authorizing entity computer;
receiving, by the processing network computer, an authorization response message from the first authorizing entity computer, the authorization response message comprising an indication that the first authorizing entity computer is unable to provide an authorization decision on the authorization response message;
determining, by the processing network computer, that the credential is associated with a flagged record;
responsive to determining that the credential is associated with the flagged record, generating, by the processing network computer, a subsequent authorization request message comprising the credential or data associated with the credential, the value, and a record value of a record managed by the first authorizing entity computer; and
transmitting, by the processing network computer, the subsequent authorization request message to a second authorizing entity computer, wherein the second authorizing entity computer authorizes or declines the subsequent authorization request message.

2. The method of claim 1, wherein the authorization request message is a second authorization request message, the authorization response message is a second authorization response message, the resource provider computer is a second resource provider computer, the value is a second value, and the interaction is a second interaction, and wherein the method further comprises, before receiving the second authorization response message:
receiving, by the processing network computer from a first resource provider computer, a first authorization request message comprising the credential or the token, and a first value for a first interaction;
transmitting, by the processing network computer, the first authorization request message comprising the credential and the first value to the first authorizing entity computer; and
receiving, by the processing network computer, a first authorization response message from the first authorizing entity computer, the first authorization response message comprising the record value and an authorization decision for a first transaction, the record associated with the first authorizing entity computer.

3. The method of claim 2, wherein the second authorization request message comprises the credential.

4. The method of claim 2, the subsequent authorization request message comprises data associated with the credential.

5. The method of claim 4, wherein the data associated the credential includes an account number that is different than the credential.

6. The method of claim 5, wherein the account number is a sixteen digit value comprising a second authorizing entity identifier associated with the second authorizing entity computer and a unique data string, and the credential is another sixteen digit number comprising a first authorizing entity identifier associated with the first authorizing entity computer.

7. The method of claim 5, wherein the account number is a first account number, and the credential is a second account number that is different than the first account number.

8. The method of claim 2, further comprising, after receiving the first authorization response message:
storing, by the processing network computer, the record value.

9. The method of claim 2, wherein the first authorization request message and the second authorization request message are ISO 8583 messages.

10. The method of claim 2, wherein the second authorization request message is received via a transport computer.

11. The method of claim 10, wherein the method further comprises:
facilitating, by the processing network computer, a transfer of the second value from the second authorizing entity computer to the transport computer.

12. The method of claim 11, wherein the transport computer manages a second resource provider record and the second resource provider record is updated to include the second value.

13. A processing network computer comprising:
a processor; and
a computer readable medium comprising instructions, executable by the processor, for performing operations comprising:
receiving, from a resource provider computer, an authorization request message comprising a credential or a token, and a value for an interaction;
transmitting the authorization request message comprising the credential, and the value to a first authorizing entity computer;
receiving an authorization response message from the first authorizing entity computer, the authorization response message comprising an indication that the first authorizing entity computer is unable to provide an authorization decision on the authorization response message;
determining that the credential is associated with a flagged record;
responsive to determining that the credential is associated with the flagged record, generating a subsequent authorization request message comprising the credential or data associated with the credential, the value, and a record value of a record managed by the first authorizing entity computer; and
transmitting the subsequent authorization request message to a second authorizing entity computer, wherein the second authorizing entity computer authorizes or declines the subsequent authorization request message.

14. The processing network computer of claim 13, wherein the authorization request message is a second authorization request message, the authorization response message is a second authorization response message, the resource provider computer is a second resource provider computer, the value is a second value, and the interaction is a second interaction, and wherein operations further comprise, before receiving the second authorization request message:
receiving, from a first resource provider computer, a first authorization request message comprising the credential or the token, and a first value for a first interaction, the credential associated;
transmitting the first authorization request message comprising the credential and the first value to the first authorizing entity computer; and
receiving a first authorization response message from the first authorizing entity computer, the first authorization response message comprising the record value and an authorization decision for a first transaction, the record associated with the first authorizing entity computer.

15. The processing network computer of claim 14, wherein the first authorization request message, the second authorization request message, and the subsequent authorization request message are ISO 8583 messages.

16. The processing network computer of claim 13, wherein the authorization request message comprises the token, and wherein the operations further comprise:
detokenizing, by the processing network computer, the token to obtain the credential.

17. The processing network computer of claim 16, wherein the token and credential are in a same data format.

18. A system comprising:
a processing network computer comprising
a processor, and
a computer readable medium comprising instructions, executable by the processor, for performing operations comprising
receiving, from a resource provider computer, an authorization request message comprising a credential or a token, and a value for an interaction,
transmitting the authorization request message comprising the credential, and the value to a first authorizing entity computer,
receiving an authorization response message from the first authorizing entity computer, the authorization response message comprising an indication that the first authorizing entity computer is unable to provide an authorization decision on the authorization response message,
determining that the credential is associated with a flagged record,
responsive to determining that the credential is associated with the flagged record, generating a subsequent authorization request message comprising the credential or data associated with the credential, the value, and a record value of a record managed by the first authorizing entity computer, and
transmitting the subsequent authorization request message to a second authorizing entity computer, wherein the second authorizing entity computer authorizes or declines the subsequent authorization request message; and
the second authorizing entity computer.

19. The system of claim 18, further comprising:
the first authorizing entity computer.

20. The system of claim 18, wherein the authorization request message is a second authorization request message, the authorization response message is a second authorization response message, the resource provider computer is a second resource provider computer, the value is a second value, and the interaction is a second interaction, and wherein operations further comprise, before receiving the second authorization request message:
receiving, from a first resource provider computer, a first authorization request message comprising the credential or the token, and a first value for a first interaction, the credential associated;
transmitting the first authorization request message comprising the credential and the first value to the first authorizing entity computer; and
receiving a first authorization response message from the first authorizing entity computer, the first authorization response message comprising the record value and an authorization decision for a first transaction, the record associated with the first authorizing entity computer.
